(19) United States
(12) Patent Application Publication
(10) Pub. No.: US 2007/0075119 A1
(43) Pub. Date: Apr. 5, 2007

(54) Solder feeder

(76) Inventor: Chung M. Wong, San Francisco, CA (US)

Correspondence Address: Chung M. Wong, 1755 14th Avenue, San Francisco, CA, 94122, US

(21) Appl. No.: 11/243,652

(22) Filed: Oct. 5, 2005

(51) Int. Cl. A47J 36/02

(52) U.S. Cl. 228/101

(57) ABSTRACT

A solder feeder includes a housing member, a solder gripper assembly with a solder guide tube, a solder holder, a trigger means, and a solder path tube receiving a straight or a curved nozzle. Solder from a solder spool is extended forward when the trigger means is engaged or activated. The solder guide tube from the solder gripper assembly recesses into the solder path tube to provide a guaranteed solder path when the solder wire is advanced forward. The solder wire is curved at a proper curvature when it escapes from a tip of the nozzle. An electric version of the solder feeder uses a DC motor to drive a pulley to wind a belt or a cable for advancing the solder wire forward. Both devices extend a length of curved solder requiring the use of only one hand and allowing a true non-stop solder operation on copper pipe joints or similar tasks.

### BACKGROUND OF THE INVENTION

1. Field of the invention

The present invention generally relates to a solder feeder and more particularly to a solder feeder which allows a plumber or tradesman to reliably dispense lengths of straight or curved solder at a solder joint with one hand while using the other hand to operate a torch in soldering copper pipe joints and similar applications. The solder feeder is capable of dispensing all types and sizes of solders currently available.

2. Description of the Prior Art

Solder is melted at high temperature to join and seal copper pipes together to form a watertight connection. Plumbers use a torch with a high temperature flame to melt solders at the joint to join copper pipes. In a typical soldering operation on copper pipes, a plumber uncoils and extends a length of solder from a solder spool with a portion of the extended solder curved to conform to the body of the copper pipe. While using one hand to hold the solder spool and place the tip of the extended length of curved solder at the joint to be sealed, the plumber uses the other hand to hold a torch and applies heat to the joint. A solder joint is formed when the solder from the extended length melts at the joint. Every time the extended length of solder is consumed, additional solder must be extended from the spool and properly curved. Extending and curving additional solder requires two hands. For safety, the plumber must put down his torch to free his hands to do so. This kind of repeated interruption prolongs the plumbing task enormously.

To save time, some plumbers often use both hands to uncoil and curve additional solder from the solder spool without putting down the torch. One obvious safety problem is that the flame from the torch may burn the plumber. Another safety problem is that the flame may ignite nearby walls, wood frames or structures when the plumber is uncoiling, extending, or bending the solder with a flaming torch still in one hand.

It is therefore desirable to provide a solder feeder which can be used to hold a solder spool capable of extending a length of undamaged curved solder through a reliable path to a work area. More importantly, the solder feeder requires only one hand to operate. Known prior art solder feeders for plumbing applications having limited success in fulfilling all these capabilities include U.S. Pat. No. 5,813,591; U.S. Pat. No. 5,421,505; and U.S. Pat. No. 3,101,689 and U.S. Pat. No. 6,027,068.

The device as described in U.S. Pat. No 5,813,591 extends a length of solder by pulling the solder spool backward a distance and then pushing the solder spool forward through a tightly coupled one-way cam. It is questionable that the somewhat soft solder wire is strong enough to reliably push through the one-way cam with only the force of the solder spool itself. Because the solder holder has no housing around it, there is no backing for the solder in any direction. When the solder spool is being pushed forward, the solder wire may escape backward or sideways if there is any resistance at the one-way cam. Also this device requires an operator to bend or curve the solder after it is extended out at the tip. Since the one-way cam is made of hard material, it may break the solder wire when the solder spool is pulled backward suddenly.

Some disadvantages of the device as described in U.S. Pat. No. 5,421,505 have been pointed out with reference to U. S. Pat. No 5,813,591. Another potential problem is the use of hard material to move the solder forward. The pressing and turning of the hard material against the solder may cause permanent destructive damage to the solder. Also, this device does not curve the solder when extending out of the tip.

The device disclosed in U.S. Pat. No. 3,101,689 also uses a hard material to press against the solder in order to move it. Other drawback is the need of initial alignment of the solder from the spool to the narrow and covered solder path and through the spring in front. Again, this device does not curve the solder when extending out of the tip.

The device disclosed in U.S. Pat. No. 6,027,068 is intended for dispensing small diameter solder for electronic PCB soldering application. It uses a toothy gear to press solder against a grooved wheel and then manually rotates the toothy gear to move the solder forward. It cannot be readily adapted to dispense large diameter solders used for plumbing soldering applications. Large diameter solders require the exertion of greater amounts of force. Large diameter solders if use in this device may stick in between the toothy gear and the grooved wheel or be broken by the toothy gear if the solder path between the toothy gear and the grooved wheel is not spaced properly.

Therefore, there exists a need in the art for a solder feeder that overcomes the disadvantages of the prior art. There is a further need for a solder feeder that uses a simple “grip & pull” concept to hold and extend a length of solder in one operation that requires only one hand to operate. There is also a need for a solder feeder operable to automatically curve the solder wire when extending the solder wire out from the device. There is a further need for a device capable of dispensing any size of solder without damaging the solder. There is also a need for a solder feeder having a tube design that ensures a reliable solder delivery path with no possibility for the solder to escape in other undesired directions.

### SUMMARY OF THE INVENTION

In accordance with one embodiment of the invention, a solder feeder includes a housing member, a solder spool holder, a solder gripper assembly, a plurality of belt rollers, a trigger lever, a solder path tube, a removable solder nozzle and a top cover. The housing member may comprise a unitary left housing member and a unitary right housing member. The left housing member may comprise a left front wall, a left base member, a left rear wall and a left handle. The right housing member may comprise a right front wall, a right base member, a right rear wall and a right handle. The solder spool holder may comprise a bottom half and a top half connected together with a hinge. Circular notches may be cut out at both sides of the top and bottom halves for seating a removable shaft. One end of the removable shaft may be a fixed circular wall and the other end may be threaded and open to receive a roll of solder spool. A threaded end cap may be used outside to lock the shaft in place when the top is swung down and snap closed.

The solder gripper assembly may comprise a base body sliding on two parallel horizontal rails horizontally. Both ends of these two horizontal rails may be mounted to the walls of the left and right housing members respectively. A left pole and a right pole may extend vertically from the base body to hold a solder path guide using two screws. Pivoting to the left pole may be a left gripper arm and to the right pole may be a right gripper arm. These two gripper arms are normally extended outward from each other by a coiled spring mounted at the poles and return springs. At the end of the left and right gripper arm are left and right rolls for gripping the solder wire running between them.

Underneath the left and right rolls may be a left blade and a right blade respectively. A screw may hold each of these two blades loosely and secure the left and the right rolls. The other end of each blade may include a hole through which extends a belt screw terminating with a belt screw cap. The trigger lever with a belt attached rolls between the grooves at the inner edges of the left and right base members of the housing members. The other end of the belt passes through a plurality of rollers mounted between the front walls of the left and right front walls to connect with the belt screw.

The solder path tube may be mounted on top of the left and right front walls of the housing member to receive the solder guide tube and allow the solder nozzle to be screwed on. Finally the top cover is screwed on the housing member using four screws on each side.

In accordance with another embodiment of the invention, a solder feeder of the same construction may include a pulley instead of the trigger lever. Additionally a trigger switch may be mounted at the front of the handle to provide a means for turning on and off a DC motor, which receives power from an externally snap on DC battery with an on/off switch. The combination of the trigger switch, a stop switch on the left front wall and a enable switch on the base member and a logic Printed Circuit Board inside the handle provides proper on/off control to the motor. The motor, pulley, switches, Printed Circuit Board and power supply are all electrically connected through cable harness in a manner known to one having ordinary skill in the art.

Both embodiments described above have the same general design except one is manually operated and the other is operated with the help of a DC motor powered by a DC power supply. Their general shape, construction, and concept of operation are similar.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will be better understood and the objectives and advantages will become apparent from the accompanying drawings and descriptions. Such descriptions make reference to the accompanying drawings wherein:

FIG. 1 is a perspective view of a solder feeder according to the present invention;

FIG. 2 is a perspective view of the solder feeder with a top cover removed and with a top half of the solder holder open to expose a solder spool on a shaft and the solder nozzle detached to show the internal mechanical structure of the present invention;

FIG. 3 is a perspective view of the solder feeder shown in FIG. 2 having a shorter version of solder nozzle installed;

FIG. 4 is a perspective view of the solder feeder in use showing the solder gripper assembly being advanced to a maximum forward position when the trigger lever is pulled all the way backward;

FIG. 5 is a side view of the solder feeder with the top cover off;

FIG. 6 is a side view of the solder feeder in use with the top cover off showing the solder trigger assembly being advanced with the solder wire all the way to its maximum front position;

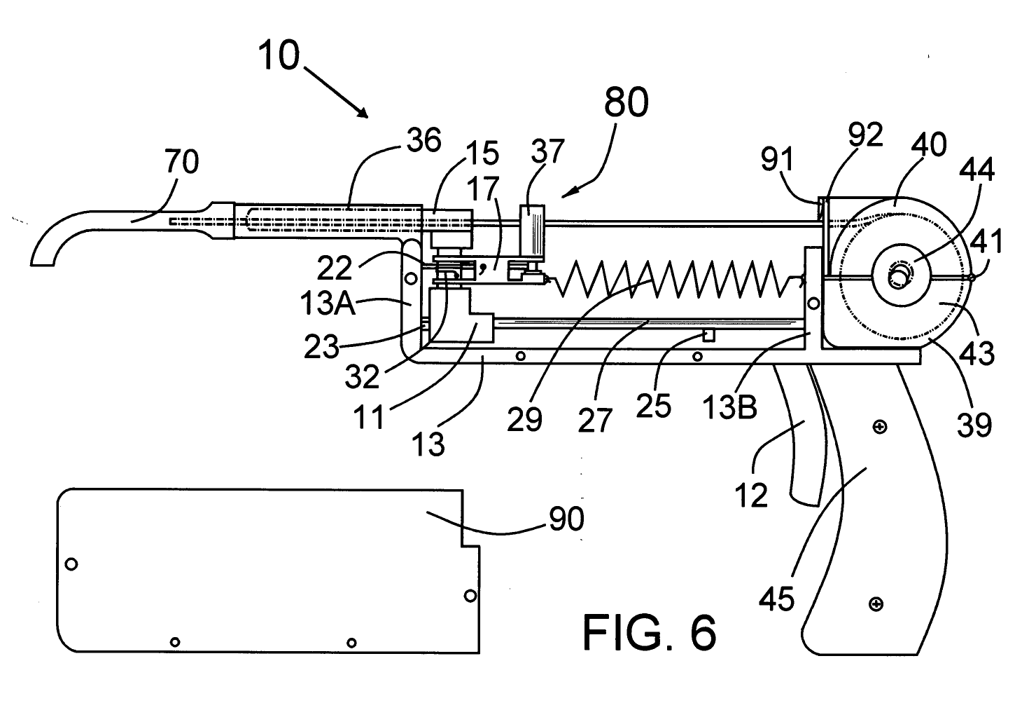

FIG. 7 is a top view of the solder feeder with the top cover off;

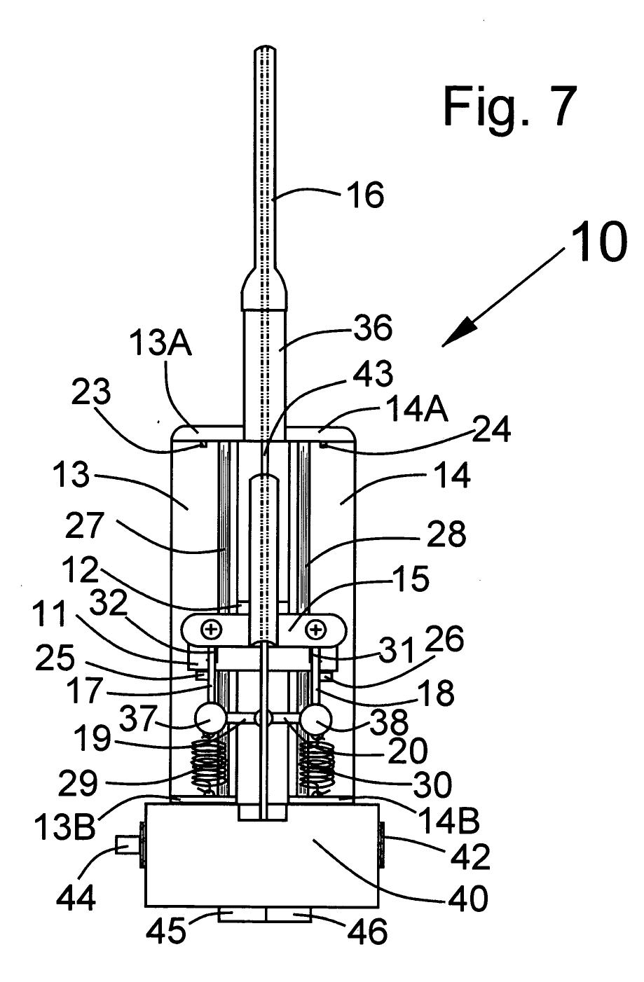

FIG. 8 is a top view of the solder feeder in use with the top cover off;

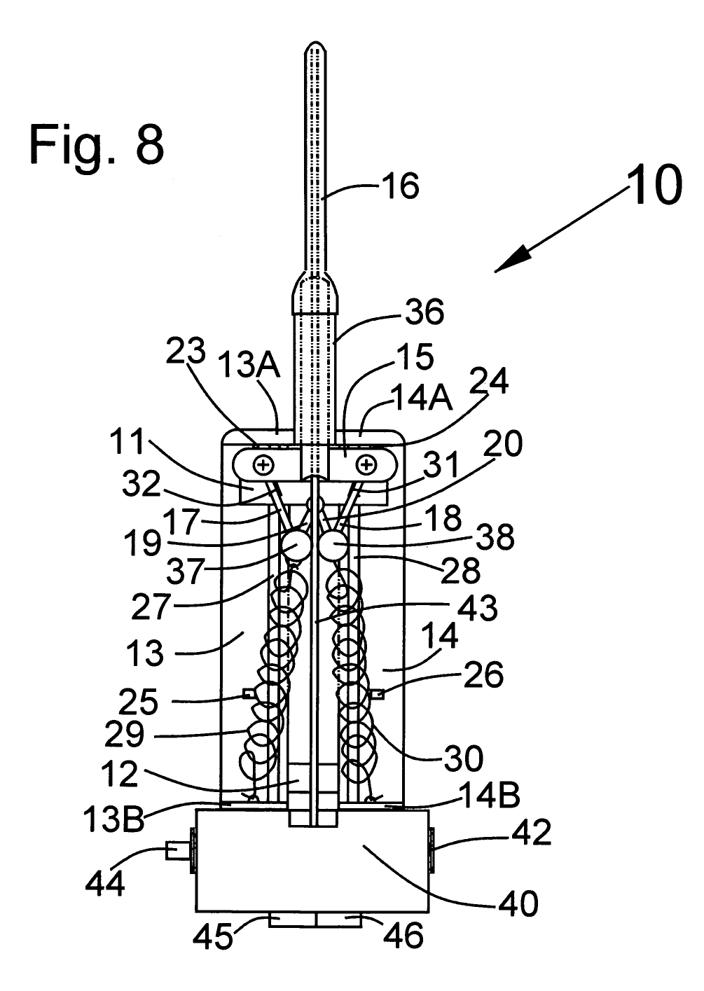

FIG. 9 is a perspective view of the solder gripper assembly;

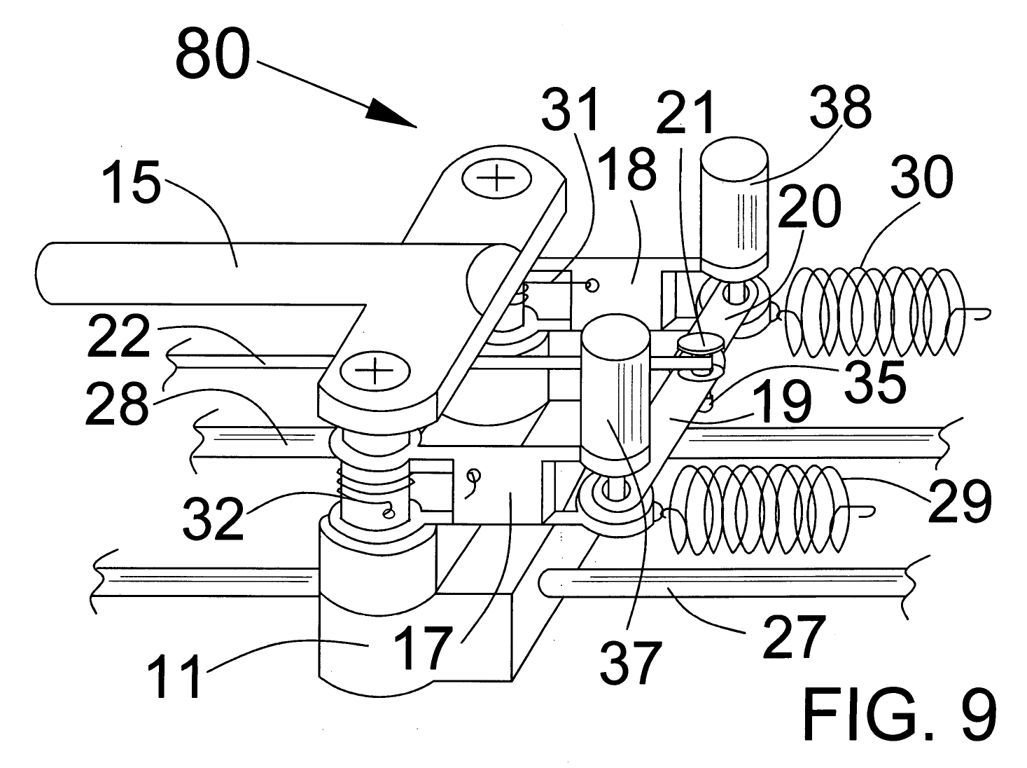

FIG. 10 is an exploded view of the solder gripper assembly;

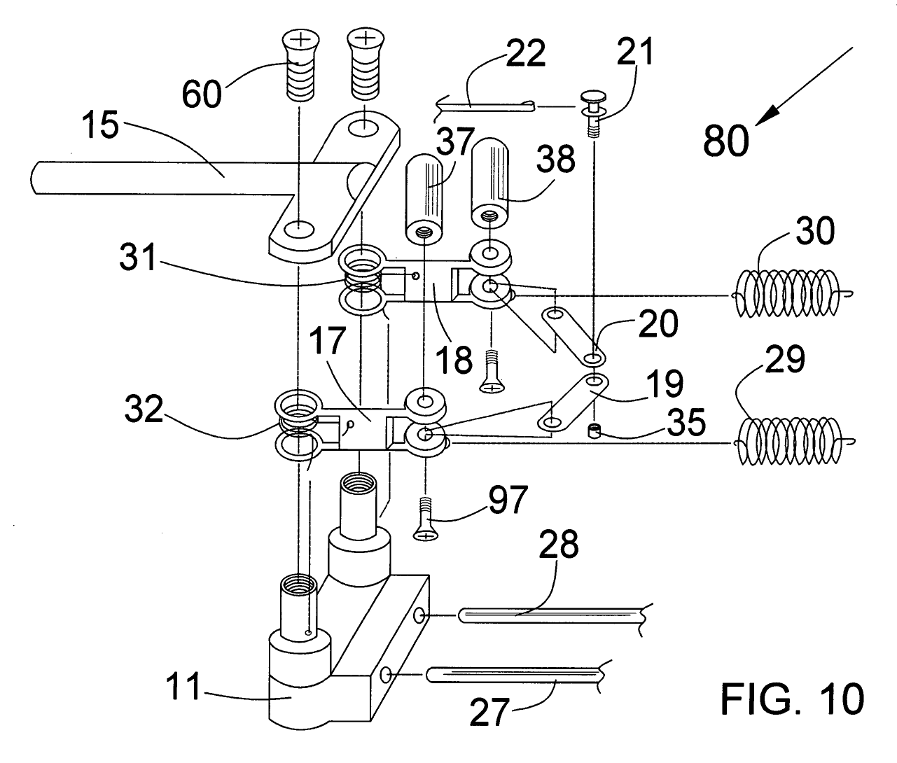

FIG. 11 is a perspective view of an alternate embodiment of the solder feeder with the top cover removed;

FIG. 12 is a perspective view of an alternate embodiment of the solder feeder in use with the top cover removed showing the solder gripper assembly being advanced to its maximum forward position;

FIG. 13 is an exploded view of the solder feeder of FIG. 2;

FIG. 14 is an exploded view of the alternate embodiment of the solder feeder show in FIG. 12; and

FIG. 15 is a schematic representation of the circuit components on the Printed Circuit Board to the motor, DC battery and control switches.

### DETAILED DESCRIPTION OF THE INVENTION

The present invention provides a solder feeder generally designated 10 for holding a spool of solder and allows an operator to extend a length of curved or straight solder at the tip using only one hand.

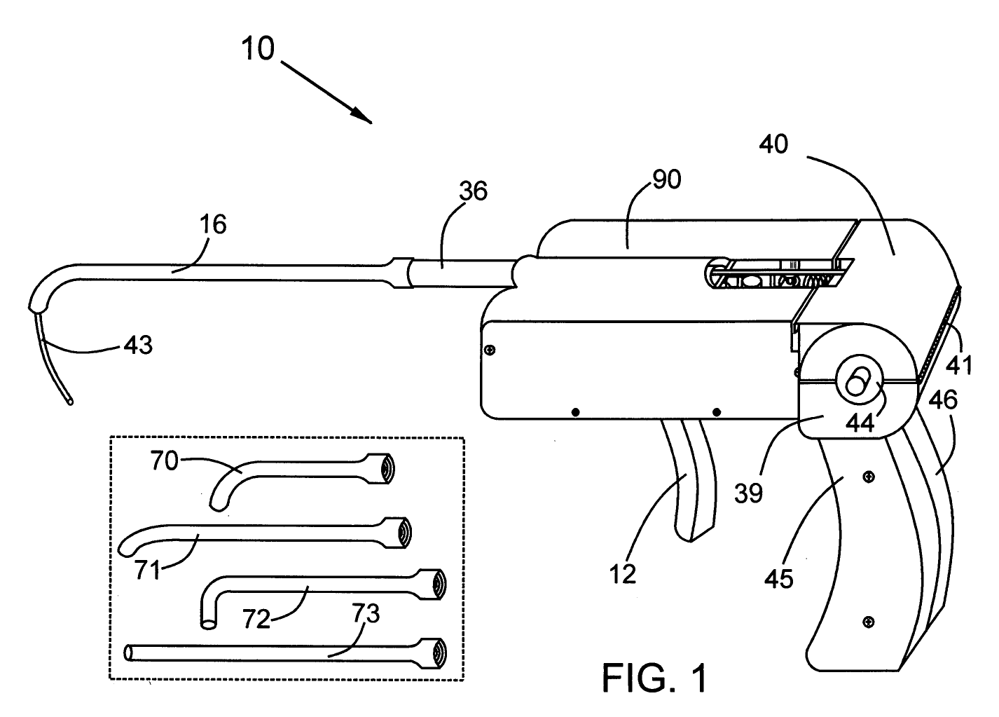

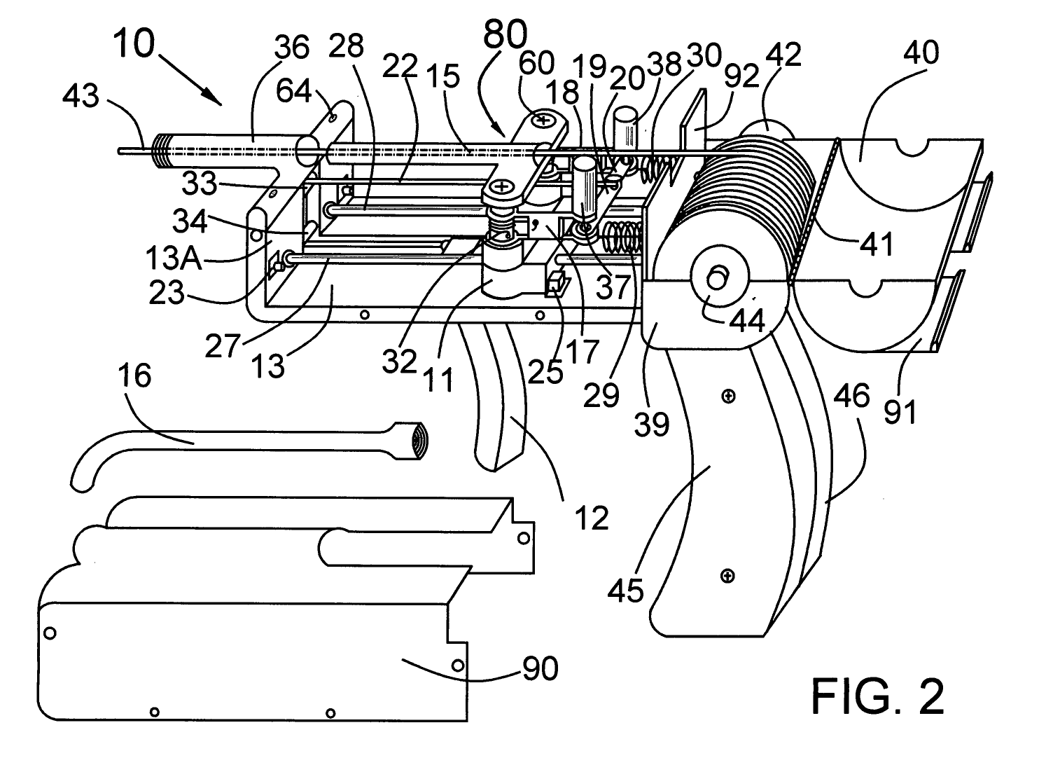

With reference to FIG. 1 and FIG. 2, the solder feeder 10 may include a left housing member 13, 13A with a left handle 45, a right housing member 14, 14A with a right handle 46, a top cover 90, and a solder gripper assembly 80. A solder holder may comprise a bottom half 39 with a sidewall 92 connected to a top half 40 by a hinge 41, a spool of solder 43 loaded onto a shaft 42 with a locking end cap 44, a trigger lever 12, a solder path tube 36, and a nozzle 16.

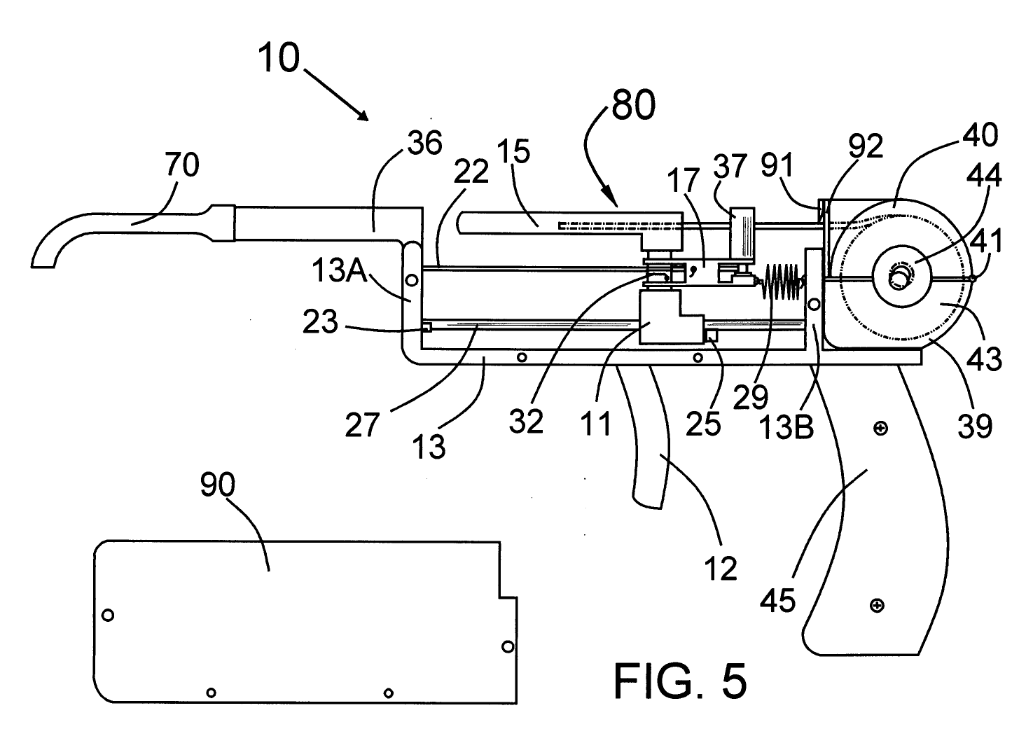

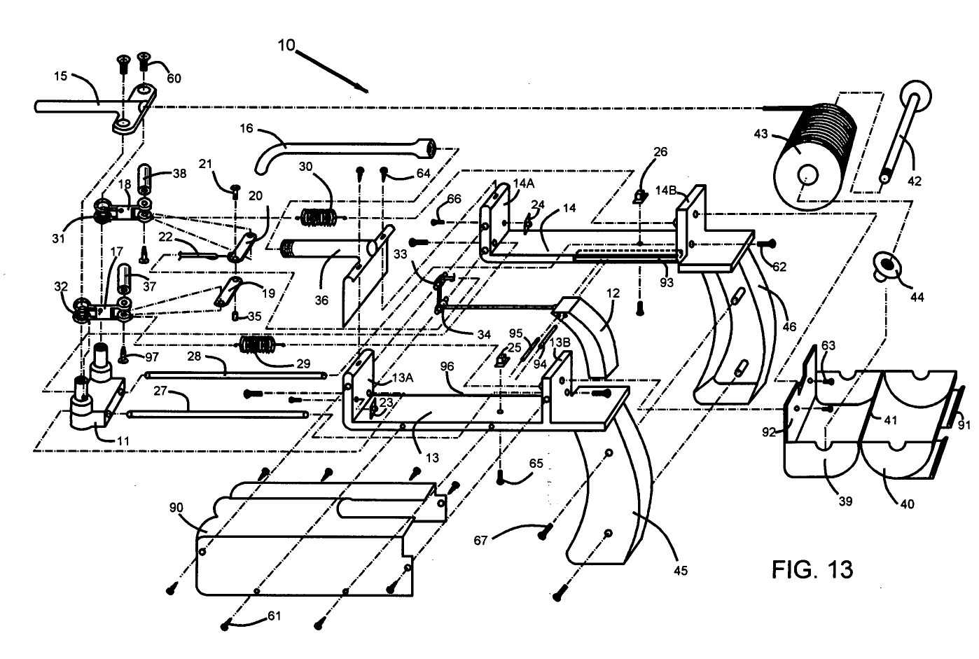

The left housing member including a left base member 13, a left front wall 13A, a left rear wall 13B and the left handle 45 may be unitarily molded into a single piece (FIG. 5 and FIG. 13). Similarly the right housing member including a right base member 14, a right front wall 14A, a right rear wall 14B and the right handle 46 may be unitarily molded into a single piece (FIG. 13). Also shown is an optional shorter, curved solder nozzle 70, a slightly curved long solder nozzle 71, a 90 degree bent solder nozzle 71, and a long straight solder nozzle 72.

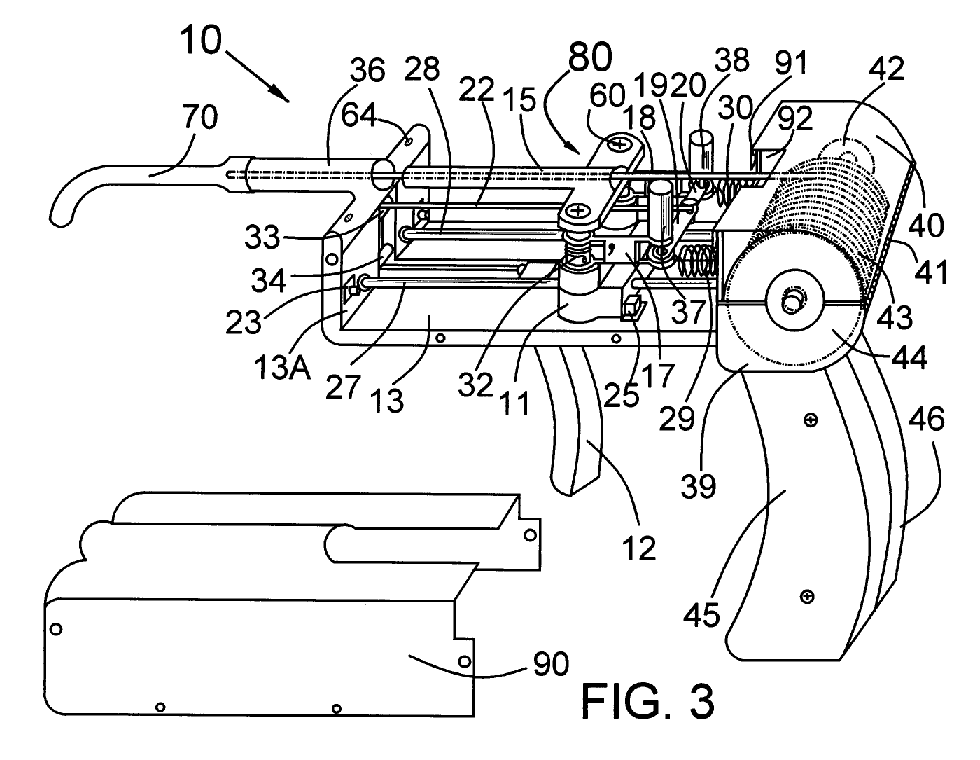

With reference to FIG. 3, the solder feeder 10 is shown with the curved solder nozzle 70 and the solder gripper assembly 80 resting at its initial standby position ready to be engaged. Top cover 90 is removed to show the internal structure.

A solder path tube 36, which is larger in diameter than a solder guide tube 15, may be mounted securely on top of the left front wall 13A and the right front wall 14A by two screws 64. The solder nozzle 70 of the solder feeder 10 may be bent at an angle for curving a solder wire when being extended out. The trigger lever 12 may be mounted at the center between the left base member 13 and the right base member 14. The trigger lever 12 has two rollers 94, 95 (FIG. 13) that may slide along a groove 96 formed at the inner edge of the left base member 13 and the groove 93 formed at the inner edge of the right base member 14.

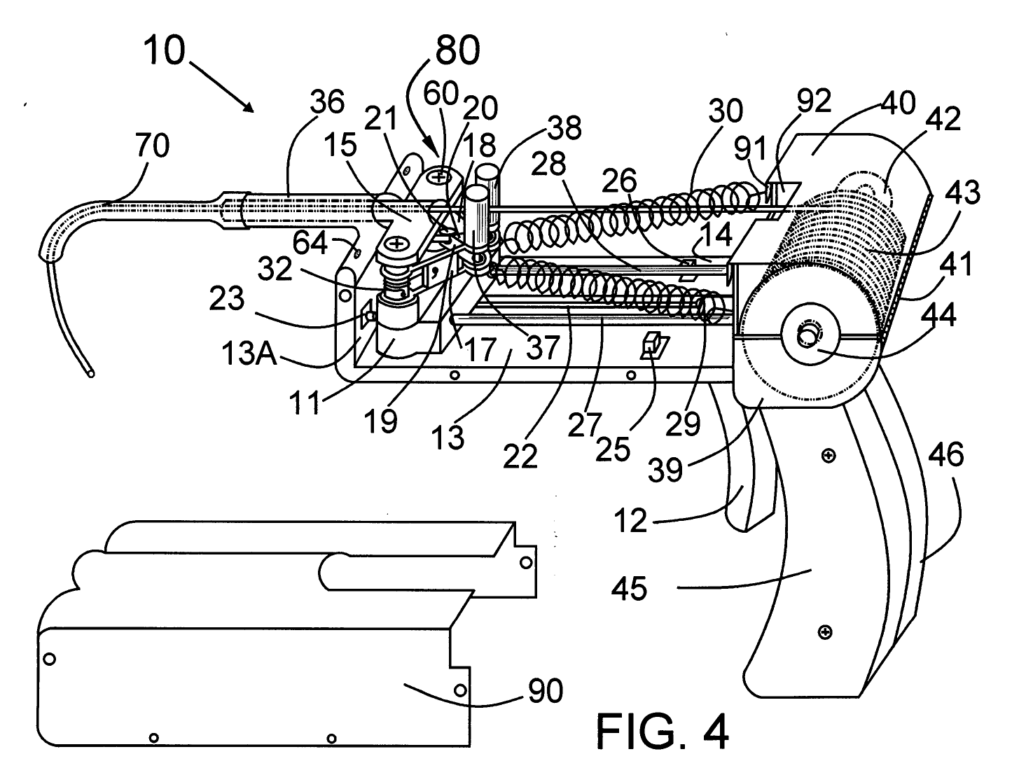

With reference to FIG. 4, the solder feeder 10 is shown in use. After a spool of solder 43 is loaded onto the removable shaft 42 and placed on the notched centers of the bottom half 39 of the solder holder, the top half 40 may be closed and lips 91 snapped over the sidewall 92 to close. The shaft 42 may be retained in position with the threaded end cap 44. Because the diameter of the shaft 42 is smaller than the hole of the solder spool 43, the solder spool 43 can rotate freely on the shaft 42 when being pulled while the shaft itself is constrained by the end cap 44 at one end and a fixed circular wall at the other end of the shaft 42. Solder wire from the solder spool 43 may be extended and fed into the solder guide tube 15 by passing it through a left gripper arms 17 and a right gripper arm 18 of the solder gripper assembly 80.

When the trigger lever 12 is pulled backward, a belt 22 may pull a left blade 19 and a right blade 20 of the solder trigger assembly 80 forward in a V-shape manner which in turn may pull the left gripper arm 17 and the right gripper arm 18 toward each other until both a left roll 37 of the left gripper arm 17 and a right roll 38 of the right gripper arm 18 sandwich the solder wire tightly there between. Diameters of rolls 37 and 38 may be sized to provide a desirable gripping force on the solder wire. Alternatively, a flexible cable may be used in place of left blade 19 and right blade 20. Continuing pulling the trigger lever 12 may move the complete solder gripper assembly 80 together with the solder wire forward along rails 27 and 28 until stop switches 23, 24 disposed at the left and right front walls 13A, 14A of the left and right housing members stop them. The solder guide tube 15 may recess into the solder path tube 36. This action may result in a length of solder being extended forward at a predefined length equivalent to the distance of the solder gripper assembly 80 being moved forward.

When the trigger level 12 is released, springs 31 and 32 may force the left gripper arm 17 and the right gripper arm 18 to separate one from the other until they are in line with their corresponding returns spring 29 and 30. Further releasing the trigger lever 12 allows the returns springs 29 and 30 to contract and return the solder gripper assembly 80 to its initial standby position.

The solder guide tube 15, being part of the solder gripper assembly 80, always moves together with the solder gripper assembly 80 to recess into the larger solder path tube 36. This overlap design ensures that the solder wire is always confined in an intended solder delivery path without any opportunity for the solder wire to escape in any undesired directions.

The sidewall 92 of the solder holder is attached to the left rear wall 13B and the right rear wall 14B of the housing member by two screws 63 (FIG. 13). The shape of the solder holder may be conformed to the shape of the solder spool 43 so as to provide a backing to the solder during forward extension to prevent the solder from escaping backward.

With reference to FIG. 5, the bottom half 39 and the top half 40 of the solder holder may be sized and configured to accept the spool of solder 43.

With reference to FIG. 3, FIG. 4 and FIG. 13, the trigger lever 12 may have two rollers 94 and 95 that slide along the two grooves 96 and 93 at the inner edges of the left and right base members 13, 14 during operation. When the trigger lever 12 is pulled backward, the belt 22 attached to the trigger lever 12 may pull the solder gripper assembly 80 together with the solder wire until the front walls 13A, 14A of the housing member stop it. When the trigger lever 12 is released, the two springs 32 and 31 may cause the two solder gripper arms 17 and 18 to open. Further releasing the trigger lever 12 may cause the solder gripper assembly 80 to return to its initial starting position by the contraction of the two returns springs 29 and 30.

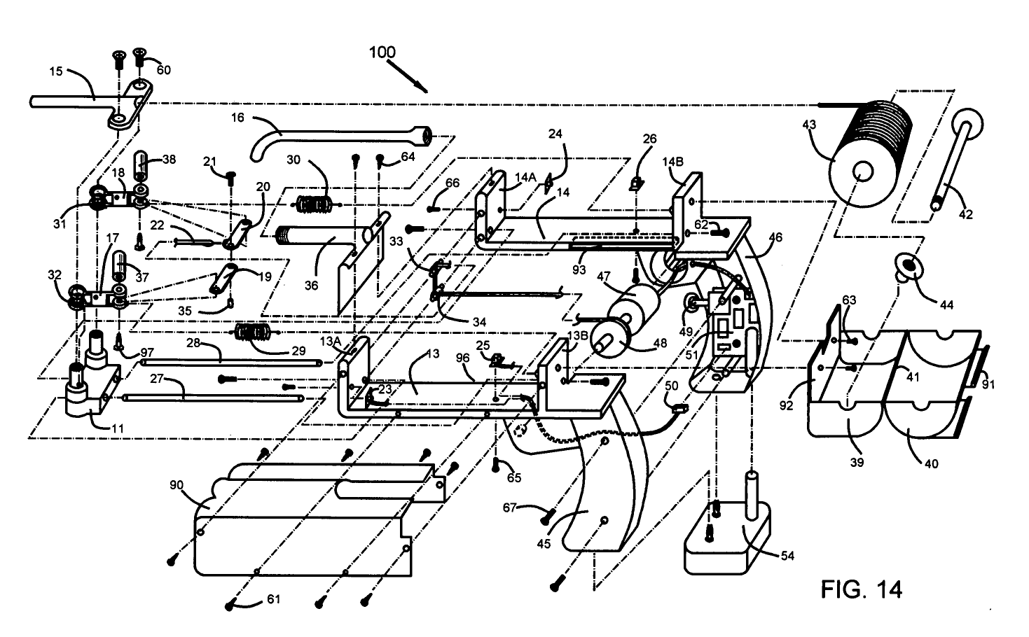

With reference to FIG. 14, the solder feeder generally designated 100 may include a DC motor 47 powered by a DC battery 54 for driving a pulley 48 to wind the belt 22 instead of a manually operated trigger lever 12 pulling the belt 22. A Printed Circuit Board 51 mounted inside the handle 55 and 56 together with the trigger switch 49, stop switch 23, enable switch 25 and cable harness 50 control the movement of the DC motor 47.

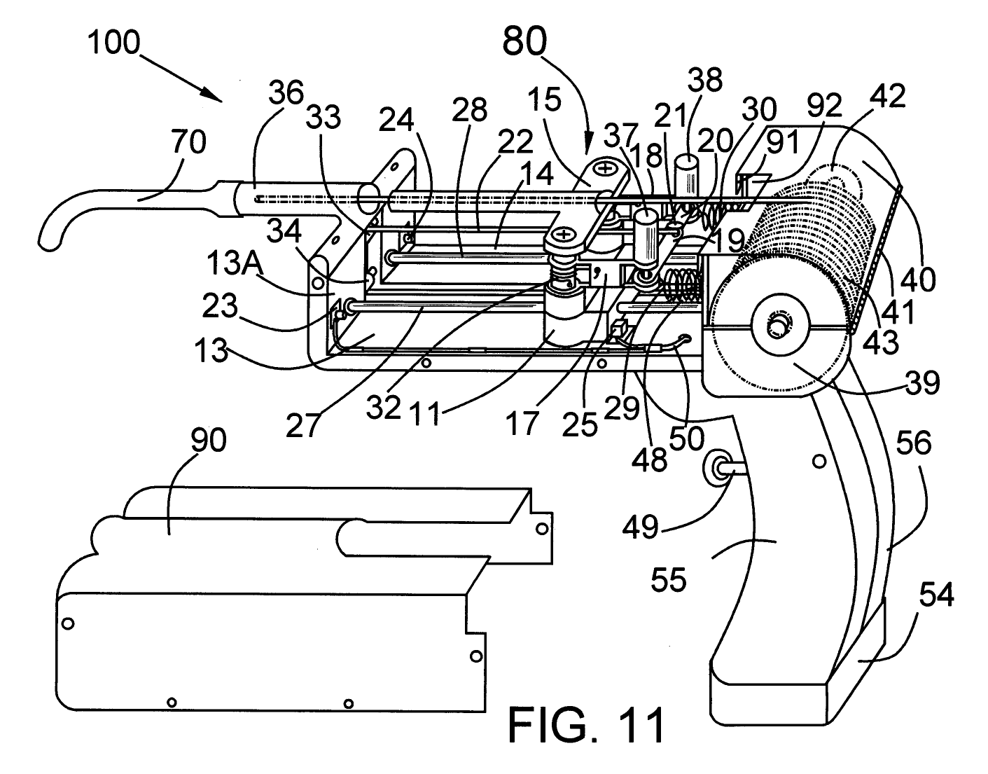

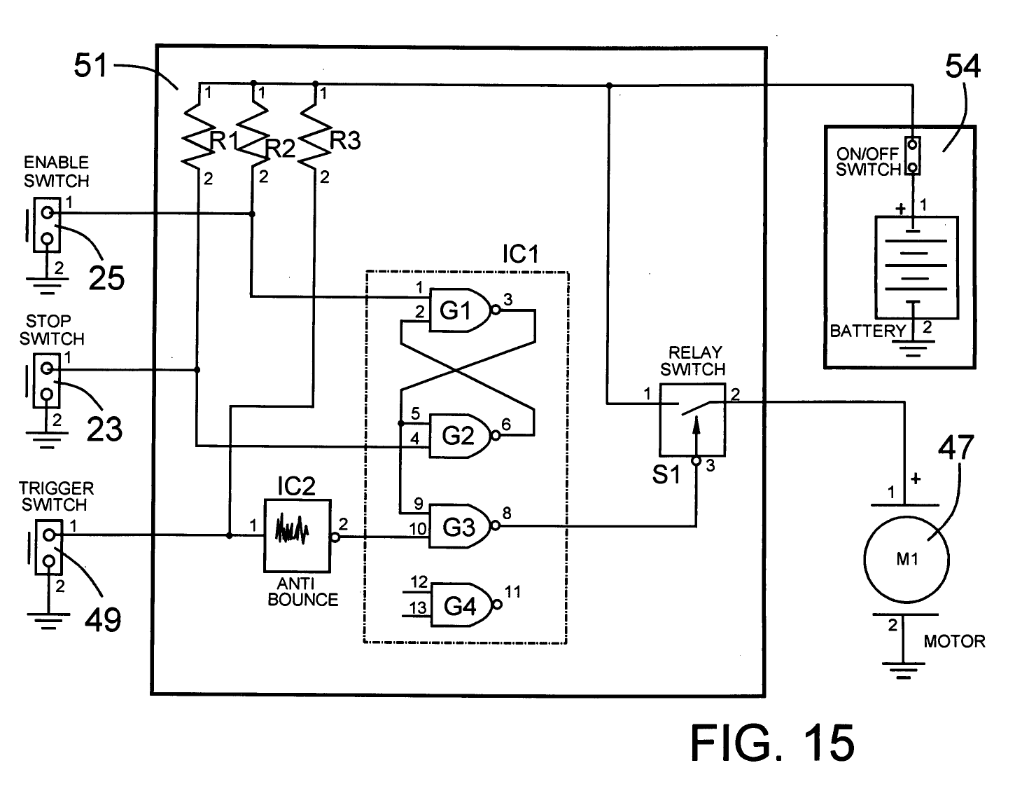

With reference to FIG. 11 and FIG. 14, solder feeder 100 is shown in standby mode. Pulling the trigger switch 49 will start the DC motor 47 and turn the pulley 48 in a direction of winding the belt 22. This action may cause the solder trigger arms 17 and 18 to move toward each other until they sandwich the solder wire in between the left roll 37 and the right roll 38 of the trigger arms 17 and 18. Further winding of the belt 22 may cause the solder trigger assembly 80 together with the solder wire to move forward until it is stopped by the stop switch 23. When the stop switch 23 is pressed, it sends a signal to the control circuits on the Printed Circuit Board 51 to stop the DC motor 47. Once the DC motor 47 is stopped, it may go into a neutral or a free running state releasing the pulley 48. Without force from the pulley 48, the two return springs 29 and 30 may contract and pull the solder trigger assembly 80 backward until it is stopped by the enable switch 25. The enable switch 25 provides an arming or enable signal to the control circuits on the Printed Circuit Board 51 [FIG. 15]. When it is enabled or armed, a push on the trigger switch 49 will turn on the DC motor 47 again.

With reference to FIG. 15, Printed Circuit Board 51 may comprise integrated circuits IC1, IC2, a relay S1, resistors R1, R2, and R3. IC1 may include a Quad 2 input NAND gate, IC2 may include a anti-bouncing circuit with inverting output, and relay S1 may include a semiconductor analog switch. Switches 23, 25 and 49 may be push button type switches wired to output a low signal when engaged, or pushed. G1 and G2 may be connected to function as a latch such that when enable switch 25 is engaged, output pin 3 of G1 would be high and when stop switch 23 is engaged, output pin 3 of G1 would be low. Output pin 3 of G1 may be connected to input pin 9 of G3. When input pin 9 is high, output pin 8 of G3 would be low whenever input pin 10 is high or the trigger switch 49 is engaged. When the input pin 9 is low, output pin 8 of G3 would be always high regardless of the signal at input pin 10 of G3. Output pin 8 of G3 may be connected to enable pin 3 of S1. When pin 3 of S1 is low, it connects input pin 1 to output pin 2 and thus allows the DC output of the battery 54 to power on the DC motor 47.

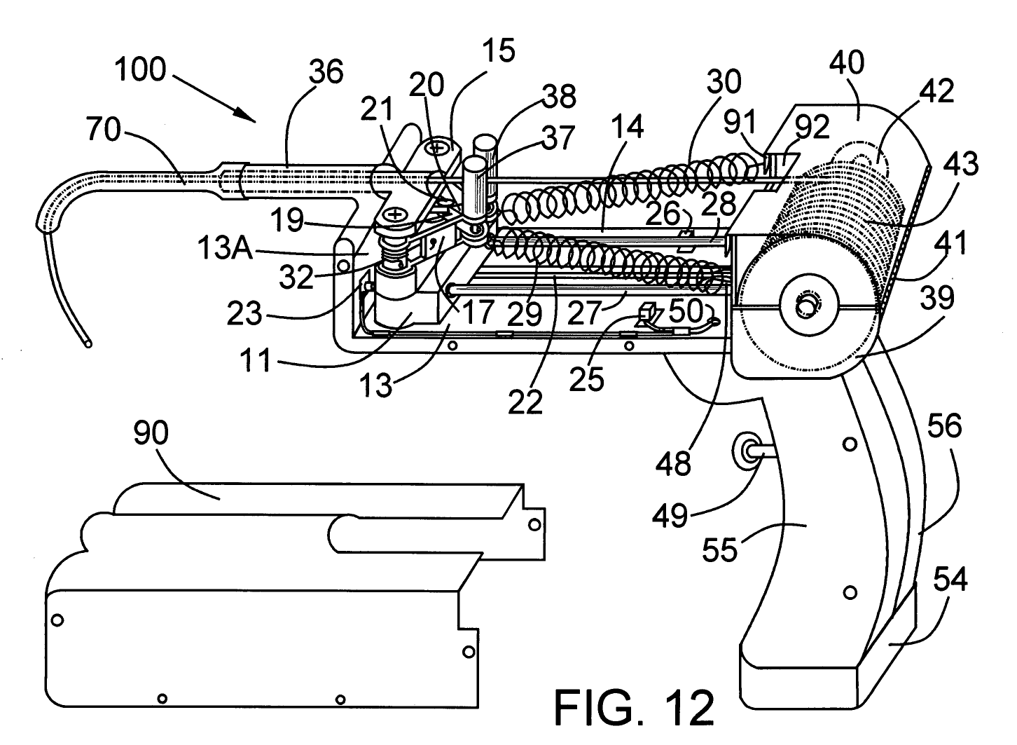

When first powered up or the device 100 is in standby mode, the enable switch 25 may be engaged by the base 11 of the solder gripper assembly 80 (FIG. 11). A low signal at pin 1 of G1 causes an output at pin 3 and input pin 9 of G3 to go high. Output of pin 8 of G3 or enable pin 3 of S1 would be low or the DC motor 47 would be powered on whenever input pin 10 of G3 is high or the trigger switch 49 is engaged. The DC motor 47 then turns the pulley 48 and advances the solder trigger assembly 80 forward until it engages the stop switch 23 (FIG. 12). When the stop switch 23 is engaged it causes the output pin 3 of G1 and the input pin 9 of G3 to go low. A low at input pin 9 causes the output pin 8 of G3 or the enable pin 3 of S1 to go high regardless of the state of the trigger switch 49. A high at pin 3 of S1 disables it and turns off the power to the DC motor 47. Without power to turn the pulley 48, the belt 22 will be unwinded by the force of the two returns springs 29 and 30 and causes the solder trigger assembly 80 to go backward until it is stopped by the enable switch 25. When the enable switch 25 is engaged, it causes the input pin 9 of G3 high again and the DC motor 47 would be powered on whenever the trigger switch 49 is engaged or pressed.

The logic diagram of FIG. 15 is for illustration purpose only, there are existing in prior arts many dc motor control circuits that can be readily adapted for this solder feeder application. However the concept of a solder feeder being controlled by dc motor to extend solder wire may be new.

The housing member 13, 45, 14, 46, trigger lever 12 and the solder holder of the solder feeder 10, 100 may be manufactured with plastic but metal or alloy is preferred for use in the solder path tube 36, the solder gripper arm 17 and 18. Very soft material or rubber is best used for the left roll 37and the right roll 38 of the solder gripper arms 17 and 18 to avoid potential damages to the solder wire. Because the tips of the solder nozzles 16 and 70 often make contact with the flame from a torch during soldering operation, it is necessary that the solder nozzle must be made of fire resistance materials such as metal or alloy

Advantageously, the solder feeder extends a length of solder and curves it at the tip of the solder nozzle allowing a plumber or tradesman to perform soldering operations on copper joints without periodically stopping to extend and curve the solder with both of their hands. With different optional solder nozzles that are easily changed, straight or curved solder wire in different degrees can be extended out as desired.

The solder feeders 10 and 100 provide an operator the ability to continuously dispenses a length of curved solder with one hand while holding a torch with the other hand during the soldering operation to greatly improving soldering speed.

I claim:

1. A solder feeder comprising:
a housing member having at least one handle;
at least two horizontal rails disposed in said housing member;
a solder gripper assembly positioned in said horizontal rails for forward and backward movement of said solder gripper assembly;
a trigger lever carried on said solder gripper assembly for displacing said solder gripper assembly along said horizontal rails;
a solder holder attached to a rear end of said housing member for holding a spool of solder thereon;
a solder guide tube for guiding solder gripped by said solder gripper assembly;
a solder path tube for receiving said solder guide tube attached to said housing member;
a solder nozzle attached at a front end of said solder path tube; and
a plurality of returns springs attached to the rear end of said housing member and said solder gripper assembly for the return of said solder gripper assembly to an initial position.

2. The solder feeder according to claim 1, wherein the housing member is of two half piece construction with the handle attached at a bottom, the solder holder attached at the rear end and said solder path tube attached at a front end.

3. The solder feeder according to claim 1, wherein the housing member secures said horizontal rails from said solder gripper assembly horizontally and spaced in parallel to each other.

4. The solder feeder according to claim 1, wherein a body of said solder gripper assembly slides forward to extend the solder wire forward and backward to return itself to the initial position.

5. The solder feeder according to claim 1, wherein the solder gripper assembly comprises two gripper arms with rubber rolls providing gripping and extending means to the solder wire.

6. The solder feeder according to claim 5, wherein the solder gripper assembly returns to its initial position by the force of the plurality of returns springs attached to said gripper arms and the rear walls of the housing member.

7. The solder feeder according to claim 1, wherein the trigger lever is attached between two base members of said housing member through a sliding means, said trigger lever being connected to said solder gripper assembly with a belt passing through a plurality of rollers.

8. The solder feeder according to claim 1, wherein said solder holder comprises a removable shaft for holding the spool of solder, the shaft being locked outside of the solder holder with a thread cap, and wherein when a cover of the solder holder is snapped closed, two side notches provide an additional locking mechanism to prevent the shaft from moving while allowing the solder spool to rotate freely on the shaft.

9. The solder feeder according to claim 8, wherein the solder holder comprises a round-shaped holder that conforms to a shape of the spool of solder to prevent the solder from escaping in any direction other than a forward direction.

10. The solder feeder according to claim 5, wherein a plurality of springs being connected to said gripper arms and the body of said solder gripper assembly separate said two gripper arms from said solder wire.

11. The solder feeder according to claim 1, wherein said solder gripper assembly provides a grip and pull action to extend said solder wire forward.

12. The solder feeder according to claim 1, wherein a solder confining means prevents said solder wire from escaping from an intended delivery path.

13. The solder feeder according to claim 1, wherein a tip portion of the solder nozzle is curved at less than 90 degree to cause the solder to curve when emerging from the tip.

14. The solder feeder according to claim 1, wherein the solder gripper assembly performs a grip and pull action that grips and extends said solder wire forward through a reliable solder path to the tip of said solder nozzle.

15. The solder feeder according to claim 1, wherein no gear or cam is used to move said solder wire forward.

16. A solder feeder comprising:
a housing member having at least one handle;
at least two horizontal rails disposed in said housing member;
a solder gripper assembly positioned in said horizontal rails for forward and backward movement of said solder gripper assembly;
a DC motor and pulley assembly carried on said housing member and attached to said solder gripper assembly for displacing said solder gripper assembly along said horizontal rails in response to the state of a plurality of control switches;
a solder holder attached to a rear end of said housing member for holding a spool of solder thereon;
a solder guide tube for guiding solder gripped by said solder gripper assembly;
a solder path tube for receiving said solder guide tube attached to said housing member;
a solder nozzle attached at a front end of said solder path tube; and
a plurality of returns springs attached to the rear end of said housing member and said solder gripper assembly for the return of said solder gripper assembly to an initial position.

17. The solder feeder according to claim 16, wherein the DC motor is turned on and off by a trigger switch, drives said pulley assembly to wind a belt in the proper direction to thereby wind the belt around the pulley assembly and cause the solder gripper assembly with said solder wire to move forward.

18. The solder feeder according to claim 17, wherein a DC power supply is disposed in the handle to provide DC power to said DC motor for driving said pulley assembly to wind said belt for pulling the solder gripper assembly with solder wire forward.

19. The solder feeder according to claim 16, wherein a printed circuit board comprises circuitry to receive signals from the plurality of control switches, the printed circuit board being mounted on said housing member for controlling the movement of said DC motor.

20. The solder feeder according to claim 19, wherein in a case where said DC motor is off and exerting no force to said pulley assembly, the plurality of returns springs pull the solder gripper assembly back to its initial starting position.
